(19) United States
(12) Patent Application Publication
(10) Pub. No.: US 2025/0284470 A1
(43) Pub. Date: Sep. 11, 2025

(54) SYSTEM OPERATION MECHANISM AUTOMATIC CONSTRUCTION DEVICE AND SYSTEM OPERATION MECHANISM AUTOMATIC CONSTRUCTION METHOD

(71) Applicant: NEC Corporation, Tokyo (JP)

(72) Inventors: Takayuki KURODA, Tokyo (JP); Takuya Kuwahara, Tokyo (JP); Eiji Muramatsu, Tokyo (JP)

(73) Assignee: NEC Corporation, Tokyo (JP)

(21) Appl. No.: 19/058,139

(22) Filed: Feb. 20, 2025

(30) Foreign Application Priority Data
Mar. 5, 2024 (JP) 2024-032783

(51) Int. Cl. G06F 8/35

(52) U.S. Cl. CPC G06F 8/35

(57) ABSTRACT

To be able to generate system configuration information so that a system can be monitored and necessary recovery procedures can be generated according to monitoring results, a fault-tolerant configuration design unit generates configuration information of a system that satisfies a given system requirement so as to satisfy a condition that a recovery procedure for each component included in the system can be generated, and when a failure occurs in any of the components, generates a recovery procedure for the component in which a failure occurs. A status monitoring procedure generation unit generates a status monitoring procedure, which is a set of a specific confirmation task for confirming a status of each component included in the system. A troubleshooting unit monitors the system using the status monitoring procedure.

### CROSS-REFERENCE TO RELATED APPLICATION

This application is based upon and claims the benefit of priority from the prior Japanese Patent Application No. 2024-032783, filed Mar. 5, 2024, the entire contents of which are incorporated herein by reference.

### BACKGROUND OF THE INVENTION

### Technical Field

This disclosure relates to a system operation mechanism automatic construction device, a system operation mechanism automatic construction method, and a system operation mechanism automatic construction program.

### Description of the Related Art

For development of industry, an active use of ICT (Information and Communication Technology) system (hereinafter simply referred to as “system”) is necessary. However, in general, complexity of a system configuration and difficulty of providing and operating such a system stably and quickly have hindered their utilization.

To address the problem, Patent Literature 1 discloses a technology for automatically constructing a system configuration that satisfies the requirements simply by providing the requirements, and furthermore, automatically operating the system so that it continues to maintain that state. This technology includes a technology for automatic generation of an operation plan based on requirements and an automatic operation technology based on operation plans.

### CITATION LIST

### Patent Literature

[Patent Literature 1] International Publication 2023/233451

### SUMMARY OF THE INVENTION

However, the purpose of the technology disclosed in Patent Literature 1 is to adjust an amount of resources such as computers and memory included in the system in response to fluctuations in demand such as system usage frequency and load. Therefore, the technology disclosed in Patent Literature 1 does not address a task of restoring a failure such as a malfunction of equipment included in the system.

It would be preferable to monitor a system and to generate system configuration information so that a necessary recovery procedure can be generated according to the monitoring result.

Therefore, the purpose of this disclosure is to provide a system operation mechanism automatic construction device, a system operation mechanism automatic construction method, and a system operation mechanism automatic construction program that monitor a system and can generate system configuration information so that a necessary recovery procedure can be generated according to the monitoring result.

The system operation mechanism automatic construction device according to the present disclosure includes fault-tolerant configuration design means for generating configuration information of a system that satisfies a given system requirement so as to satisfy a condition that a recovery procedure for each component included in the system can be generated, and generating a recovery procedure for the component in which a failure occurs when a failure occurs in any of the components, status monitoring procedure generation means for generating a status monitoring procedure which is a set of specific confirmation tasks for confirming a status of each component included in the system, and troubleshooting means for monitoring the system using the status monitoring procedure.

The system operation mechanism automatic construction method according to the present disclosure, wherein a computer generates configuration information of a system that satisfies a given system requirement so as to satisfy a condition that a recovery procedure for each component included in the system can be generated, the computer generates a status monitoring procedure which is a set of specific confirmation tasks for confirming a status of each component included in the system, the computer monitors the system using the status monitoring procedure, and the computer generates the recovery procedure for the component in which a failure occurs when a failure occurs in any of the components.

The system operation mechanism automatic construction program according to the present disclosure causes a computer to execute a fault-tolerant configuration design process of generating configuration information of a system that satisfies a given system requirement so as to satisfy a condition that a recovery procedure for each component included in the system can be generated, a status monitoring procedure generation process of generating a status monitoring procedure which is a set of specific confirmation tasks for confirming a status of each component included in the system, a troubleshooting process of monitoring the system using the status monitoring procedure, and a recovery procedure generation process of the recovery procedure for the component in which a failure occurs when a failure occurs in any of the components.

According to this invention, it is possible to monitor a system and generate system configuration information so that a necessary recovery procedure can be generated according to the monitoring result.

### BRIEF DESCRIPTION OF THE DRAWINGS

FIG. 1: It depicts a block diagram showing an example of the configuration of the system operation mechanism automatic construction device of the present disclosure.

FIG. 2: It depicts an explanatory diagram showing an example of system configuration information.

FIG. 3: It depicts an explanatory diagram showing the recovery procedure.

FIG. 4: It depicts an explanatory diagram showing an example of a specific recovery procedure.

FIG. 5: It depicts an explanatory diagram showing an example definition of an agent and its method.

FIG. 6: It depicts an explanatory diagram showing an example of a system requirement.

FIG. 7: It depicts an explanatory diagram showing an example of the status monitoring procedure.

FIG. 8: It depicts a flowchart showing an overview of a processing flow when a system requirement is input.

FIG. 9: It depicts a flowchart showing an overview of processing flow of the system operation mechanism automatic construction device during operation of a constructed system.

FIG. 10: It depicts an explanatory diagram showing an example of a component type model.

FIG. 11: It depicts an explanatory diagram showing an example of a status element.

FIG. 12: It depicts an explanatory diagram showing an example of a description of an expected configuration in a component type model of an APServer-type.

FIG. 13: It depicts a graph showing an example of a status transition system.

FIG. 14: It depicts an explanatory diagram showing an example of a task described in a status element.

FIG. 15: It depicts an explanatory diagram showing an example of a status confirmation task described in a status element.

FIG. 16: It depicts a schematic graph showing an example of a materialization of a proposed configuration information.

FIG. 17: It depicts a graph showing a dependency relationship among components included in the configuration information, represented by dotted arrows.

FIG. 18: It depicts a schematic block diagram showing an example of a computer configuration for a system operation mechanism automatic construction device.

FIG. 19: It depicts a block diagram showing an overview of a system operation mechanism automatic construction device of the present disclosure.

FIG. 20: It depicts a graph showing an example of a system configuration in which an agent has been added.

### DESCRIPTION OF THE PREFERRED EMBODIMENTS

Hereinafter, an example embodiment of the present disclosure will be explained with reference to the drawings.

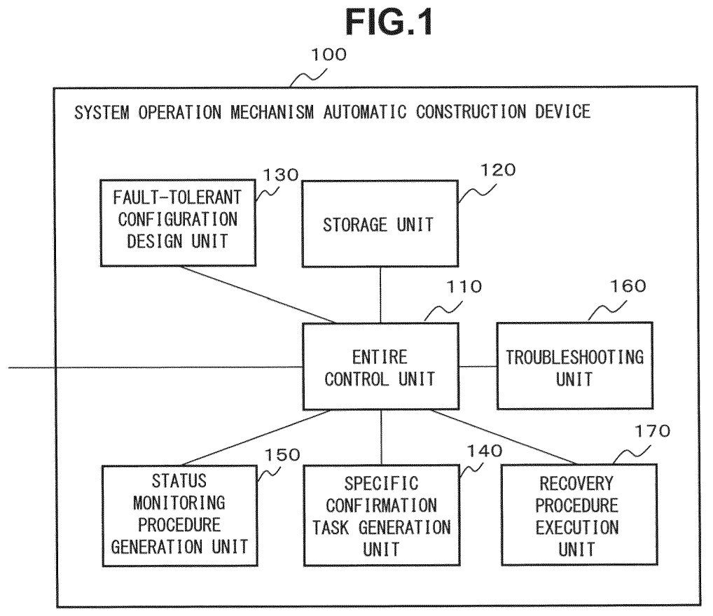

FIG. 1 is a block diagram showing an example of the configuration of the system operation mechanism automatic construction device of the present disclosure. The system operation mechanism automatic construction device 100 of this disclosure includes an entire control unit 110, a storage unit 120, a fault-tolerant configuration design unit 130, a specific confirmation task generation unit 140, a status monitoring procedure generation unit 150, a troubleshooting unit 160, and a recovery procedure execution unit 170. The entire control unit 110 is communicatively connected to an external input/output device (not shown).

The entire control unit 110 provides a user with an automatic system design function and an automatic operation function through an input/output device.

Specifically, the entire control unit 110 accepts a system requirement for the system that the user wants to build. Then, the entire control unit 110 makes the fault-tolerant configuration design unit 130 generate configuration information for the system that satisfies the system requirement and a recovery procedure for each component included in the system. The entire control unit 110 also makes the specific confirmation task generation unit 140 a generate specific confirmation task. The specific confirmation task is a task to confirm the status of each component included in the system and is generated for each component. The entire control unit 110 makes the status monitoring procedure generation unit 150 generate the status monitoring procedure which is a set of specific confirmation tasks. Furthermore, the entire control unit 110 generates a system id for the system, and associates the system configuration information and the status monitoring procedure with the system id and stores them in the storage unit 120. The entire control unit 110 then outputs the system id to the user.

The entire control unit 110 accepts the system id of the system that the user wants to operate from the user, and reads the configuration information and the status monitoring procedure associated with that system id from the storage unit 120. Then, the entire control unit 110 makes the troubleshooting unit 160 monitor system status using the status monitoring procedure, and when a failure (for example, a malfunction) occurs, the entire control unit 110 makes the fault-tolerant configuration design unit 130 generate a recovery procedure for the component in which the failure occurs. The entire control unit 110 then makes the recovery procedure execution unit 170 execute the recovery procedure.

The storage unit 120 is a storage device that stores the system configuration information and the status monitoring procedure associated with the system id. In addition, a component type model for each component of the system and a status element for each component are stored in advance in storage unit 120. The component type model and the status element are described below.

The fault-tolerant configuration design unit 130 accepts a system requirement and generates configuration information for a system that satisfies the system requirement so that it satisfies the condition that it can generate recovery procedures for each component contained in the system.

In addition, when a failure occurs in any of the components the fault-tolerant configuration design unit 130 generates a recovery procedure for the component in which the failure occurs.

The fault-tolerant configuration design unit 130 and other units obtain a component type model and a status element necessary for operation from the storage unit 120 through the entire control unit 110.

The specific confirmation task generation unit 140 generates a specific confirmation task for each component included in the system using the system configuration information, the component type model, and the status element.

The status monitoring procedure generation unit 150 generates a status monitoring procedure which is a set of specific confirmation tasks, using the system configuration information, each specific confirmation task, and the component type model.

The troubleshooting unit 160 accepts a status monitoring procedure, monitors the system using the status monitoring procedure, and identifies a component in which a failure occurs when an abnormal status is detected.

The recovery procedure execution unit 170 accepts a recovery procedure and executes the recovery procedure to recover a component in which a failure occurs, thereby recovering the system.

The entire control unit 110, the fault-tolerant configuration design unit 130, the specific confirmation task generation unit 140, the status monitoring procedure generation unit 150, the troubleshooting unit 160, and the recovery procedure execution unit 170 are realized, for example, by a CPU (Central Processing Unit) of a computer that operates according to a system operation mechanism automatic construction program. In this case, the CPU may read the system operation mechanism automatic construction program from a program storage device or other program storage medium of the computer, and operate as the entire control unit 110, the fault-tolerant configuration design unit 130, the specific confirmation task generation unit 140, the status monitoring procedure generation unit 150, the troubleshooting unit 160, and the recovery procedure execution unit 170, according to the system operation mechanism automatic construction program.

The storage unit 120 is realized by a storage device provided in the computer described above, for example.

Next, the data, etc. generated by the system operation mechanism automatic construction device 100 will be explained. The component type model and the status element stored in the storage unit 120 are described below, along with a description of the operation.

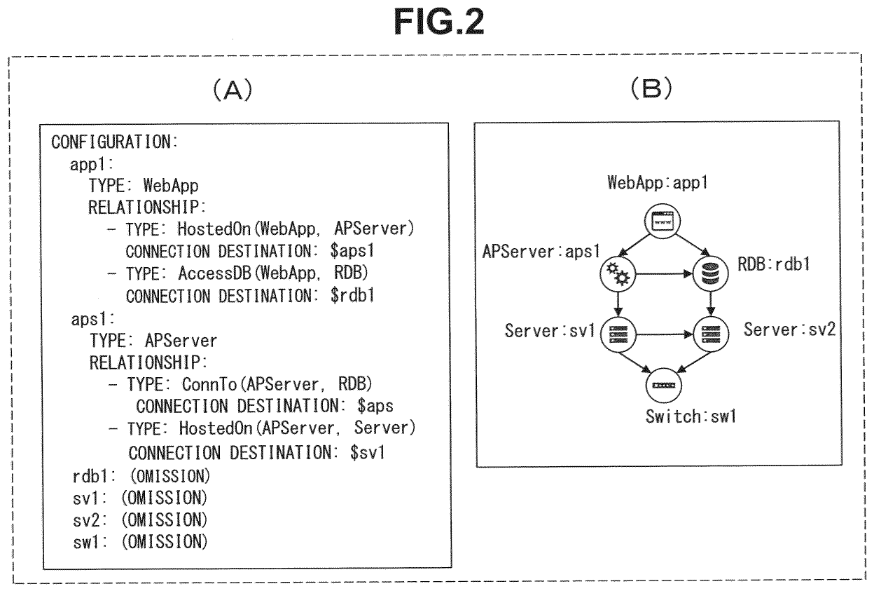

FIG. 2 is an explanatory diagram showing an example of system configuration information. (A) in FIG. 2 shows an example of system configuration information, and (B) in FIG. 2 shows a graph that visually represents the system configuration represented by the configuration information. The system configuration information is described in text, as shown in (A) of FIG. 2.

The graph representing the system configuration (see (B) in FIG. 2) includes nodes and edges. A node represents a part that makes up the system and is called a configuration part. An edge represents a relationship among configuration parts and is called a relationship. A configuration part and a relationship are collectively called a component.

Each component includes at least the id of the component and a type that means a type of the component. However, the id of the relationship is omitted in this specification. In addition to the id and the type, each component may include additional information such as properties.

In the graph illustrated in (B) of FIG. 2, a circle represents a configuration part, and an arrow connecting circles represents a relationship. A label attached to the component indicates a type and an id, with the type to the left of the colon “:” and the id to the right of the colon. Either or both the type and the id may be omitted from the figure as appropriate. An icon for the type is shown in the circle representing the configuration part, as appropriate.

The configuration information shown in (A) of FIG. 2 is described in a YAML (Yet Another Markup Language) format. The configuration information has a “configuration” (see (A) in FIG. 2).

In the “configuration”, the ids of the configuration parts included in the system are enumerated. In the example shown in (A) of FIG. 2, ids such as “app1” and “aps1” are listed. The information of each configuration part is described as an attribute of each id. Specifically, “type” and “relationship” are described for each id. The “type” is a type of the configuration part. The “relationship” is a relationship from one configuration part to another. The “relationship” is represented as an array. The “type” of the relationship and the “connection destination” are described as an attribute of each relationship. The “type” of a relationship composed of a basic type which is a type of the relationship itself, and two end types which are the types of the configuration parts at both ends. For example, when HostedOn (Web App, APServer) is described, HostedOn is the basic type, and WebApp and APServer are the two end types.

In the “connection destination”, the id of the configuration part with which a relationship is formed is described in a reference format. The reference format is a string of the id followed by “$”, indicating that it refers to another element.

The configuration information illustrated in (A) of FIG. 2 includes six configuration parts, “app1”, “aps1”, “rdb1”, “sv1”, “sv2”, and “sw1”. Taking “app1” as an example, the type of the configuration part whose id is “app1” is the WebApp type. This configuration part includes a relationship of a HostedOn (WebApp, APServer) type with “aps1” as the connection destination, and a relationship of an AccessDB (WebApp, RDB) type with “rdb1” as the connection destination.

The configuration information is an output for a system requirement that corresponds to an input to the system operation mechanism automatic construction device. The configuration information represents the system configuration. The method of describing system requirement is the same as the method of describing configuration information.

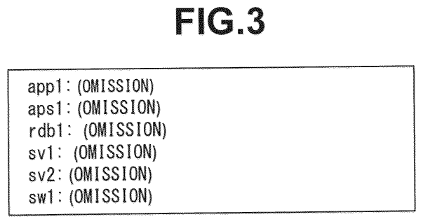

FIG. 3 is an explanatory diagram showing the recovery procedure. However, in FIG. 3, the description of specific recovery procedures is omitted. As shown in FIG. 3, the recovery procedure is described for each component id.

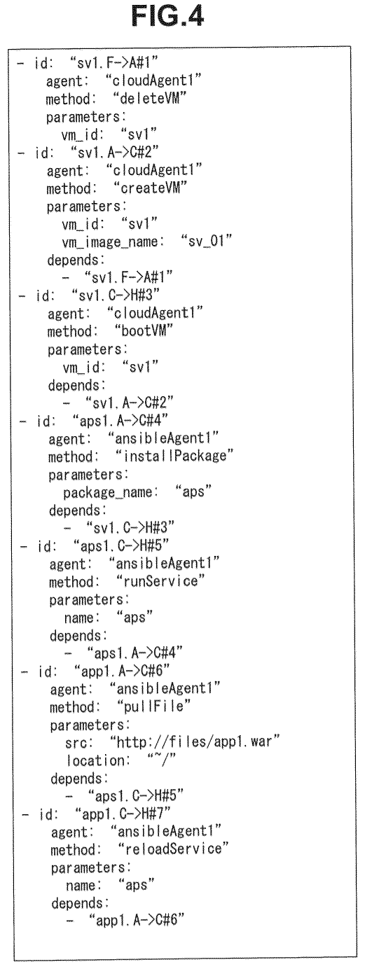

FIG. 4 is an explanatory diagram showing an example of a specific recovery procedure. FIG. 4 shows an example of a recovery procedure when a failure (for example, a malfunction) occurs in a Server-type component whose id is “sv1” (hereinafter described as Server:sv1) in the configuration information shown in FIG. 2. In other words, the recovery procedure shown in FIG. 4 is described as the recovery procedure corresponding to “sv1” among the recovery procedures whose description is omitted in FIG. 3. The following explanation uses the case where the failure is a malfunction as an example.

A recovery procedure is an ordered set of tasks. Each task in the recovery procedure described with id, agent, method, parameters, and depends. The id is an identifier of the task with that id. The agent is an id of the executor of that task. The method is a task to be performed by the agent. The parameters are arguments given to the method. The depends indicates an id of another task that should be executed beforehand. Thus, for the first task, depends is omitted.

The agent and method that can be described in the recovery procedure are predefined. In the example shown in FIG. 4, the agent named cloudAgent and ansibleAgent have appeared. For cloudAgent, methods such as deleteVM, createVM, and bootVM are called. For ansibleAgent, methods such as installPackage, runService, pullFile, and reloadService are called. These methods are defined with the agent in advance.

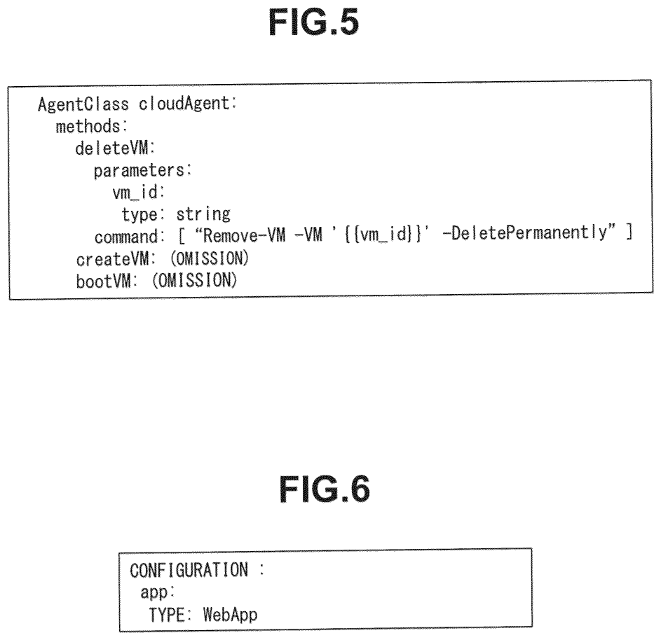

FIG. 5 is an explanatory diagram showing an example definition of an agent and its method. FIG. 5 shows an example of cloudAgent and its method. FIG. 5 also shows an example of the contents of deleteVM. The description part of command shown in FIG. 5 represents the command that is actually executed by the OS (Operating System). In the {{vm_id}} part, the value of vm_id defined in the parameters shown in FIG. 4 is inserted. The command description part often contains a complex and lengthy command string (character string). As shown in FIG. 5, by defining the agent and its method, the actual complex execution details can be commonized and hidden. As a result, within the recovery procedure, it is possible to avoid describing specific and detailed commands each time, and to concisely describe the work to be performed.

The first task shown in FIG. 4 is a task whose id is “sv1.F->A#1”. This task causes the agent with the id “cloudAgent1” to execute the method “deleteVM”. When executing the method, it is indicated that the string “sv1” is given to deleteVM as the value of the argument named vm_id. Since this is the first task, depends is omitted.

The second task listed in FIG. 4 is a task with id “sv1.A->C#2”. Since “sv1.F->A#1” in the depends of this task, this second task is executed after the task with id “sv1.F->A#1”.

The recovery procedure describes a series of operations to restore the entire system to a normal state when a malfunction occurs in a certain component. For example, the recovery procedure shown in FIG. 4 is a recovery procedure when Server:sv1 in the configuration information shown in FIG. 2 falls into malfunction. When Server:sv1 falls into malfunction, since APServer:aps1 which depends on Server:sv1, and WebApp:app1 which depends on APServer:aps1, will stop in a chain reaction, the recovery procedure shown in FIG. 4 also includes operations for recovering APServer:aps1 and WebApp:app1.

FIG. 6 is an explanatory diagram showing an example of a system requirement. As mentioned above, the method of describing system requirements is the same as the method of describing configuration information. Therefore, it can be said that a system requirement is a form of configuration information. However, unlike the generated configuration information, the system requirement does not need to specifically describe all the components necessary for operation. In the system requirement, only necessary parts need to be described at a necessary and sufficient level of abstraction. In the example shown in FIG. 6, since it is only required to run a Web application, it indicates a system requirement that includes only one WebApp type component.

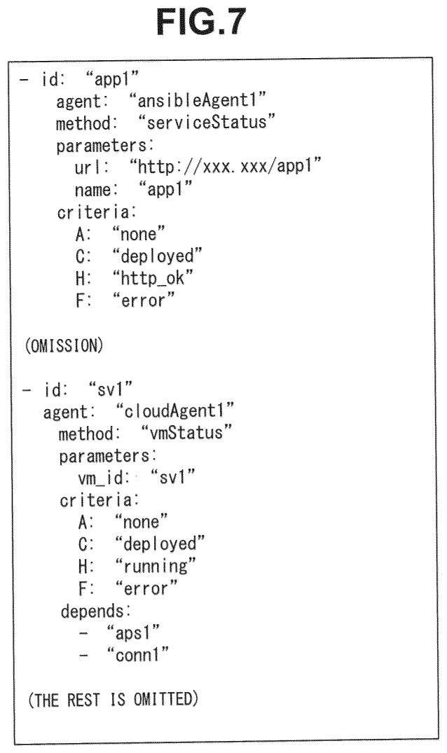

FIG. 7 is an explanatory diagram showing an example of the status monitoring procedure. The status monitoring procedure is an ordered set of specific confirmation tasks. A component that should be monitored regularly is called a regularly monitored target. The status monitoring procedure includes the specific confirmation task to confirm the state of the regularly monitored target (called the first specific confirmation task) and the specific confirmation task to identify the component in which a malfunction occurred when the regularly monitored target is in an abnormal status (called the second specific confirmation task). The description specification of the status monitoring procedure is almost the same as that of the recovery procedure. However, in the status monitoring procedure, the id of the component whose status is to be confirmed is described as the id. In the status monitoring procedure, each specific confirmation task includes criteria. The criteria is information that links the execution result of a method to the status of a component. In the criteria, a message obtained as a result of execution is associated with each character string (“A”, “C”, “H”, and “F” in the example shown in FIG. 7) indicating the possible states of the target component (see FIG. 7). However, the method described in the status monitoring procedure is assumed to return a message as the execution result.

For example, the first specific confirmation task shown in FIG. 7 is a specific confirmation task that monitors the status of “app1”. In this specific confirmation task, the method “serviceStatus” of the agent whose id is “ansibleAgent1” is executed with two arguments: url: “http://xxx. xxx/app1” and name: “app1”. The status of “app1” is then determined according to the return value message. Specifically, when the obtained message is “none”, the status of “app1” is determined to be “A”. When the obtained message is “deployed”, the status of “app1” is determined to be “C”. When the obtained message is “http_ok”, the status of “app1” is determined to be “H”. When the obtained message is “error”, the status of “app1” is determined to be “F”.

Among the specific confirmation tasks included in the status monitoring procedure, a specific confirmation task that does not have “depends” is the first specific confirmation task. A specific confirmation task that has “depends” is the second specific confirmation task. The second specific confirmation task is executed after the other specific confirmation tasks described in its depends are executed. The second specific confirmation task is executed sequentially according to the description in depends, and the component judged to be in an abnormal status immediately before the component determined to be in a normal state is determined to be the component in which the malfunction occurred.

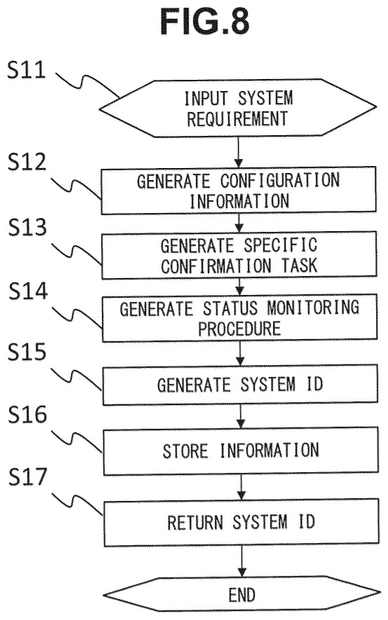

The following is an overview of the processing flow. After an overview of the processing flow is described, detailed operations will be explained. FIG. 8 is a flowchart showing an overview of processing flow when the system requirement is input.

When a system requirement is input by a user through an input/output device (step S11), the entire control unit 110 accepts the system requirement and sends it to the fault-tolerant configuration design unit 130.

The fault-tolerant configuration design unit 130 generates configuration information for the system that satisfies that system requirement so that it satisfies the condition that it can generate a recovery procedure for each component contained in the system (step S12). At this time, the fault-tolerant configuration design unit 130 takes the configuration information representing the system requirement as an initial state of the configuration information. Then, the fault-tolerant configuration design unit 130 generates configuration information by repeatedly executing of materializing the configuration information one step, and of selecting, among the proposed configuration information obtained by materialization, proposed configuration information that can generate a recovery procedure for each component included in the proposed configuration information. Therefore, the fault-tolerant configuration design unit 130 also generates a recovery procedure for each component in step S12.

When a new component is added as materialization of the configuration information, the fault-tolerant configuration design unit 130 generates the proposed configuration information by determining the id of the added component, identifying the type and relationship of the added component, and describing the id, type and the relationship in the configuration information.

The fault-tolerant configuration design unit 130 returns the generated configuration information to the entire control unit 110. The entire control unit 110 sends the configuration information generated in step S12 to the specific confirmation task generation unit 140.

The specific confirmation task generation unit 140 generates a specific confirmation task for each component included in that configuration information (step S13) and returns each specific confirmation task to the entire control unit 110.

The entire control unit 110 sends the configuration information generated in step S12 and each specific confirmation task to the status monitoring procedure generation unit 150.

The status monitoring procedure generation unit 150 generates a status monitoring procedure that is a set of ordered specific confirmation tasks (step S14). In this case, the status monitoring procedure generation unit 150 generates a status monitoring procedure that includes the first specific confirmation task and the second specific confirmation task.

The status monitoring procedure generation unit 150 returns the generated status monitoring procedure to the entire control unit 110.

The entire control unit 110 generates a system id of the system that the configuration information represents (step S15). Then, the entire control unit 110 associates the system id with the configuration information generated in step S12 and the status monitoring procedure, and stores them in the storage unit 120 (step S16).

The entire control unit 110 then returns the system id to the user through the input/output device (step S17).

The above is an overview of the processing flow when system requirement is input. After the above process, the system represented by the configuration information is constructed. This system may be constructed manually or automatically.

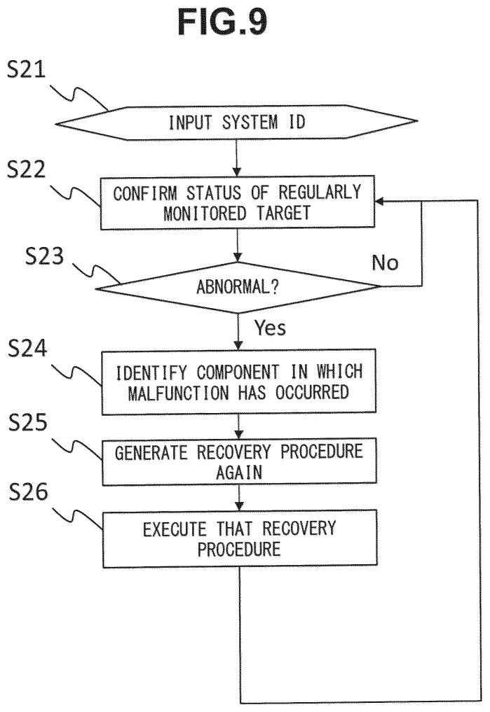

FIG. 9 is a flowchart showing an overview of processing flow of the system operation mechanism automatic construction device during operation of the constructed system.

When the system id of the system that the user wants to operate is input by the user through the input/output device (step S21), the entire control unit 110 accepts that system id. Then, the entire control unit 110 reads the status monitoring procedure associated with the system id from the storage unit 120 and sends the status monitoring procedure to the troubleshooting unit 160.

The troubleshooting unit 160 confirms the status of the regularly monitored target according to the status monitoring procedure (step S22). The troubleshooting unit 160 confirms the status of the regularly monitored target according to the specific confirmation task without depends (i.e., the first specific confirmation task) among each specific confirmation task included in the status monitoring procedure.

When the status of the regularly monitored target is normal (No in step S23), the troubleshooting unit 160 waits for a certain period of time and then executes step S22 again.

When the state of the regularly monitored target is abnormal (Yes in step S23), the troubleshooting unit 160 identifies the component in which a malfunction has occurred according to the status monitoring procedure (step S24). At this time, the troubleshooting unit 160 identifies the component in which a malfunction has occurred according to the second specific confirmation task included in the status monitoring procedure. More specifically, the troubleshooting unit 160 executes the second specific confirmation task sequentially according to the description of depends, and identifies the component that was determined to be in an abnormal status immediately before the component that was determined to be in a normal state as the component in which the malfunction occurred.

The troubleshooting unit 160 sends the system id and the id of the component in which a malfunction occurs to the fault-tolerant configuration design unit 130 through the entire control unit 110.

The fault-tolerant configuration design unit 130 again generates the recovery procedure in the event that a component identified by the above component id falls into malfunction in the monitored system (step S25).

The fault-tolerant configuration design unit 130 sends the recovery procedure to the recovery procedure execution unit 170 through the entire control unit 110.

The recovery procedure execution unit 170 executes that recovery procedure to restore the system by restoring the component in which a malfunction occurs (step S26).

After step S26, repeat the operation from step 22 onward.

As mentioned above, the recovery procedure for each component is generated in step S12. However, since the data volume of the recovery procedure for each component is large as a whole, it may not be appropriate to store the recovery procedure for each component associated with the system id in the storage unit 120. Therefore, in this example embodiment, the recovery procedure generated with the configuration information in step S12 are not stored in the storage unit 120, and when a component in which a malfunction occurs, the fault-tolerant configuration design unit 130 generates the recovery procedure corresponding to the component again.

If there is no problem in storing all the recovery procedures for each component generated in step S12 in the storage unit 120, the entire control unit 110 may associate the system id with the configuration information, its recovery procedure and the status monitoring procedure, and store them in the storage unit 120 in step S16. In this case, it is not necessary to perform step 25, and the recovery procedure execution unit 170 can obtain the recovery procedure corresponding to the id of the component in which a malfunction occurs through the entire control unit 110 and execute that recovery procedure.

Next, the details of step S12 will be explained.

The fault-tolerant configuration design unit 130 accepts a system requirement and generates specific configuration information. At this time, the fault-tolerant configuration design unit 130 generates the configuration information so that all components included in the configuration information have recovery procedures.

The basic operation for generating specific configuration information from the system requirement is a search process such that the system requirement is the initial state and the specific configuration information is a target state. At each step, the fault-tolerant configuration design unit 130 generates multiple candidates for the proposed configuration information, which are obtained by materializing the proposed configuration information being the current state one step. The fault-tolerant configuration design unit 130 repeats the process of evaluating the validity of the generated proposed configuration information and selecting the most valid proposed configuration information. A one-step materialization is a process of either replacing the type with a more specific type or supplementing one of the expected configurations for each component in the proposed configuration information. A proposed configuration information is considered to be specific when, for all components included in the proposed configuration information, the type is specific and the expected configuration is in a state of completion. Information on whether a type of a component is specific or not and the expected configuration of that type are described in the component type model of that component.

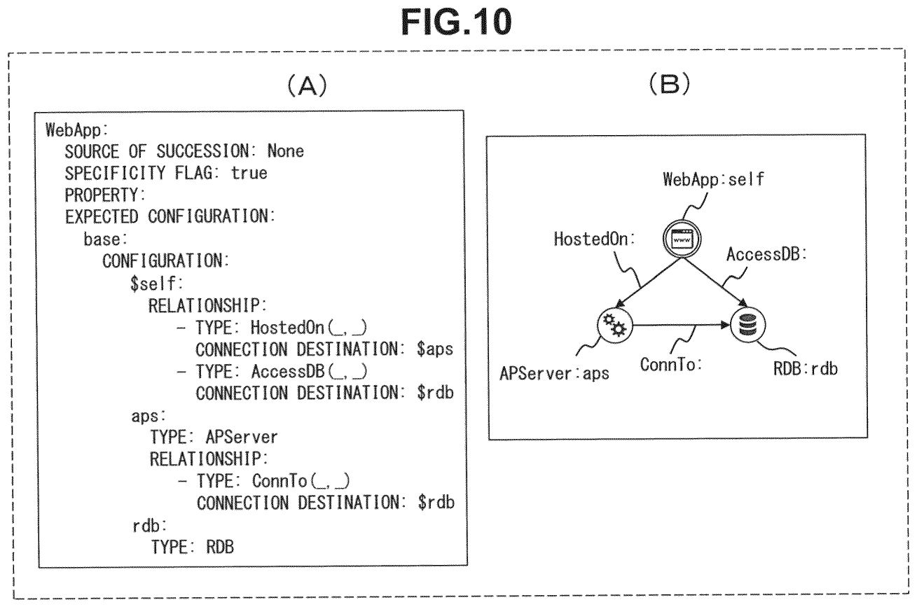

FIG. 10 is an explanatory diagram showing an example of a component type model. (A) in FIG. 10 shown an example of a component type model, and (B) in FIG. 10 shown a graph representing the expected configuration described in that configuration information type model. The component type model is described in text, as shown in (A) of FIG. 10. FIG. 10 illustrates an example of a WebApp type component type model. The component type model is generated in advance for each configuration part.

A component type model has a component type (WebApp in the example shown in (A) of FIG. 10), a source of succession, a specificity flag, a property, and an expected configuration. In the example shown in (A) of FIG. 10, the lines from “base” to the last line represent an expected configuration. “Base” is the name of the expected configuration and may be a string other than “base”.

Each component type can succeed the type by specifying the name of another component type as the source of succession. By succeeding another component type, the component type succeeds the information of the source of succession and is extended or overwritten by appending only the parts that differ from the type information of the source of succession. The succeeded type is called a derived type, an extended type, etc., and is considered to be a type of the source of succession.

The specificity flag is a flag indicating whether the type is specific or not.

The property is information that represents an attribute value that the type can hold.

The expected configuration is a surrounding configuration that must be satisfied in order for a configuration part having a certain type to establish specific configuration information. For example, a configuration part of WebApp type (see (A) in FIG. 10) must be connected to a configuration part of APServer type by a relationship of HostedOn (WebApp, APServer) type, and a configuration part of WebApp type must be connected to a configuration part of RDB type by a relationship of AccessDB (WebApp, RDB) type. Furthermore, a configuration part of the above APServer type must be connected to a configuration part of the RDB type by a relationship of ConnTo (APServer, RDB) type. Such a condition that a configuration part requires of its surrounding configurations is specified as the expected configuration. Although a single component type model can contain multiple expected configurations, this specification shall not deal with examples of expected configuration type models that contain two or more expected configurations.

As mentioned above, in the example shown in (A) of FIG. 10, the lines from “base” to the last line represent a single expected configuration. (B) in FIG. 10 is a visual representation of this single expected configuration. The expected configuration is represented as a partial configuration that includes the configuration part type itself that seeks the expected configuration. In the graph of the expected configuration shown in (B) of FIG. 10, the configuration part itself that seeks the expected configuration is represented by a double-line circle.

As mentioned above, a single component type model can include multiple expected configurations, but this specification does not deal with examples of the component type model that include two or more expected configuration. Therefore, in this specification, the expected configurations included in one component type model are represented by a single graph, as shown in (B) of FIG. 10.

In the component type model (for example, see (A) of FIG. 10), both end types of the relationship type are omitted and represented as appropriate.

The component type model shown in (A) of FIG. 10 describes “source of succession”, “specificity flag”, “property”, and “expected configuration. Since a component type model can contain multiple expected configurations, the name of the expected configuration is described and then the information of the expected configuration is described. As mentioned above, in the component type model shown in (A) of FIG. 10, “base” is the name of the expected configuration. Next to the name of the expected configuration, the content of the expected configuration is described in the same format as the configuration information. However, the id of the type itself seeking the expected configuration is described as $self, which is a special reference format.

When both end types of a relationship type are omitted by “_”, the types of both end components specified in the component type model shall be used for the omitted part. For example, in the component type model shown in (A) of FIG. 10, the first relationship “HostedOn(_,_),” which is held by $self, has $self as the connection source and $aps as the connection destination. Since $self is described as a WebApp type itself and the type of $aps is APServer (see (A) of FIG. 10), the formal type name of this relationship is interpreted as HostedOn(WebApp, APServer).

In order to generate configuration information so that all components have recovery procedures, the fault-tolerant configuration design unit 130 searches for specific proposed configuration information while rejecting proposed configuration information for which recovery procedures cannot be generated. In other words, the fault-tolerant configuration design unit 130 selects proposed configuration information in which each component has a recovery procedure by evaluating the validity of the proposed configuration information generated in the one-step materialization in terms of whether each component included in the configuration information proposal can generate a recovery procedure. Therefore, when the fault-tolerant configuration design unit 130 generates proposed configuration information, the fault-tolerant configuration design unit 130 tries to generate a recovery procedure for each component included in the proposed configuration information and selects proposed configuration information for which recovery procedures can be generated for each component.

The fault-tolerant configuration design unit 130 generates information on the status transition system before generating the recovery procedure. The information on the status transition system is necessary for the generation of the recovery procedure. The information on the status transition system is generated by associating it with the configuration information (proposed configuration information). The fault-tolerant configuration design unit 130 adds a component to the proposed configuration information by supplementing the expected configuration to the proposed configuration information before materialization in one step of materialization of the proposed configuration information. Next, the fault-tolerant configuration design unit 130 adds the status element information of the added component to the status transition system associated with the proposed configuration information before materialization, to generate a status transition system associated with the proposed configuration information after materialization. For example, suppose that the proposed configuration information Q is generated by adding the component A to the proposed configuration information P. In this case, the fault-tolerant configuration design unit 130 adds the status element of the component A to the status transition system associated with the proposed configuration information P to generate the status transition system associated with the proposed configuration information Q.

Here, the status element is information that summarizes a set of possible states of a component and the state transitions that can occur. The status transition system is information that links multiple status elements by dependency relationship among them.

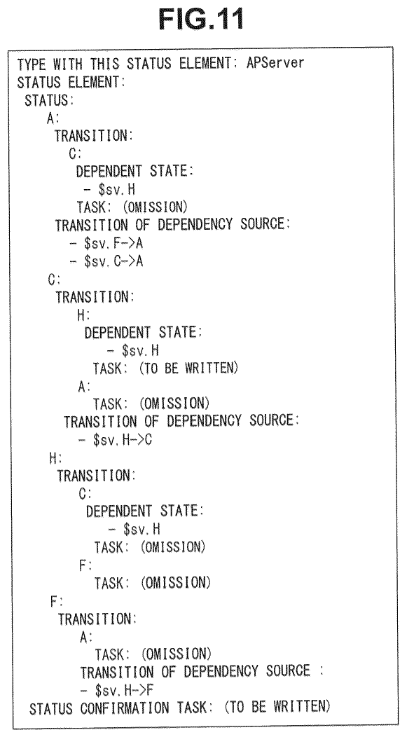

FIG. 11 is an explanatory diagram showing an example of a status element. FIG. 11 shows an example of an APServer type status element. A status element is generated in advance for each configuration part.

A status element has a “type with this status element” and a “status element” (see FIG. 11). The “type with this status element” is a type of the component corresponding to the status element. The “status element” indicates a content of the status element. The “status element” has a “state” and a “status confirmation task”. In the “state”, multiple states are listed. In the “status confirmation task”, a task to check the state of the component corresponding to the status element is described in a format that includes a reference format. In each state, a string that represents the state id is described, and its contents are described as “transition” and “transition of dependency source” (see FIG. 11). In the “transition”, the destination states that can be transitioned from the state under focus are described, and each destination state defines a “dependent state” and a “task”. As the “dependent state”, the state of other components that must be satisfied when the transition is executed is described. In the “task”, a recovery task described below is described in a format that includes a reference format. In the “transition of dependency source”, transitions in other components that should depend on the state under focus are described. Here, A depends on B means that A needs B.

When other components are described in “dependent state” or “transition of dependency source”, they are described in a reference format as shown in FIG. 11. In this case, other components are described so as to refer to the components listed in the expected configuration indicated by the component type model corresponding to a type having status elements including the “dependent state” and the “transition of dependency source” (APServer type in the example of FIG. 11). The same applies when other components are referenced within a “task” or “status confirmation task” included in a status element.

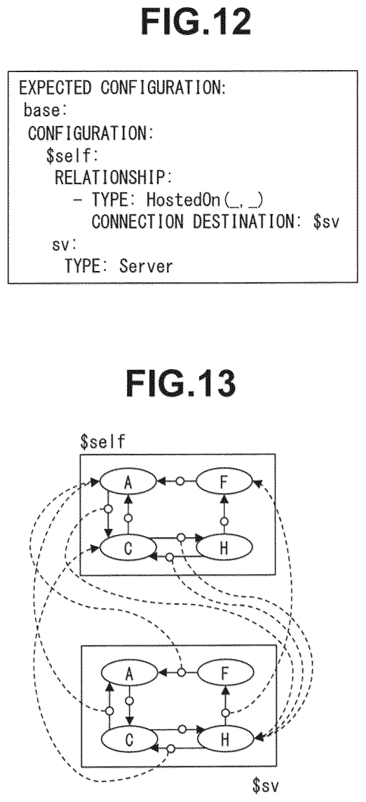

For example, FIG. 11 shows the description “$sv.F->A”. FIG. 11 represents a status element of APServer. The “$sv.F->A” above represents the transition from state F to state A in the Server type component. Here, the Server type component for APServer corresponds to “sv1” for “aps1” shown in FIG. 2, for example. Therefore, the component type model of the APServer type includes the description of the expected configuration shown in FIG. 12. As referenced in sv in FIG. 12, other components are described in the “dependent state” and “transition of dependency source” in a reference format.

In the example of the status element shown in FIG. 11, four states are defined as “A”, “C”, “H”, and “F”. State “A” has a transition to state “C”. The transition from state “A” to state “C” depends on the state “H” of the component $sv. That is, to transition from state “A” to state “C”, the component $sv needs to be in state “H”. Furthermore, state “A” is dependent on the transition from state “F” to state “A” of the component $sv and the transition from state “C” to “A”. In other words, the state of the APServer must be in “A” when the component $sv transitions from state “F” to state “A”, or when the component $sv transitions from state “C” to “A”.

FIG. 13 represents a status transition system that indicates the same content as FIG. 11. The rectangle shown in FIG. 13 represents a single status element. Ellipses indicate states, solid arrows between ellipses indicate transitions, and dotted arrows between transitions and states indicate dependencies.

FIG. 11 shows the status element of the APServer, and Server:sv is described as the expected configuration in the component type model of the APServer (see FIG. 12). Therefore, when complementing the expected configuration, the fault-tolerant configuration design unit 130 adds Server to the proposed configuration information. When complementing the status transition system with that addition, the fault-tolerant configuration design unit 130 adds status element of the Server to the status transition system and adds the dependency between the APServer and Server to the status transition system. This results in the status transition system shown in FIG. 13 when focusing only on the APServer and Server. The dependencies between the status elements indicated by the Server status element are added to the status transition system when materializing the Server.

The fault-tolerant configuration design unit 130 generates recovery procedures for each component using the generated status transition system. In Japanese Laid-Open Patent Publication No. 2015-215885 (hereinafter referred to as Ref. 1), a method for calculating possible status transition procedures from a certain current state to a specific target state is described in a status transition system as described above. The fault-tolerant configuration design unit 130, for example, uses the method described in Ref. 1 to generate a status transition procedure that transfers the states of all status elements from the current state to the target state without violating dependencies among the status elements. However, the method of generating the status transition procedure is not limited to the method described in Ref. 1, and other methods may be used.

The fault-tolerant configuration design unit 130 determines the current state and the target state when generating a recovery procedure for a certain component as follows. The fault-tolerant configuration design unit 130 determines the current state as the state in which the component under focus is in a fault state (here, “F”) and the states of all other components in the proposed configuration information are normal (here, “H”). The fault-tolerant configuration design unit 130 determines the state in which all the components in the proposed configuration information are in a normal state (here, “H”) as the target state. Then, the fault-tolerant configuration design unit 130 generates a status transition procedure from the current state to the target state. The fault-tolerant configuration design unit 130 generates status transition procedures for each component included in the proposed configuration information as described above. However, when the recovery procedure is generated in step S25 (see FIG. 9), the status transition procedure should be generated as described above only for the component in which a failure occurs. The process of generating the recovery procedure after generating the status transition procedure is common to step S12 and step S25. The fault-tolerant configuration design unit 130 generates one recovery procedure based on one status transition procedure.

The normal state and the fault state of each component is defined in advance. In this example embodiment, for simplicity of explanation, all status elements are assumed to have the state “H” and the state “F”. Suppose “H” is the normal state and “F” is the fault state. However, it may be possible to define various specific states for each component as normal and fault states.

The fault-tolerant configuration design unit 130 generates a recovery procedure from one status transition procedure by the following process. The generation of the transition procedure provides information on the status transition procedure as follows, for example.
(1) The state of $sv is from A to C.
(2) The state of $aps1 is from A to C.
(3) The state of $app1 is from A to C.

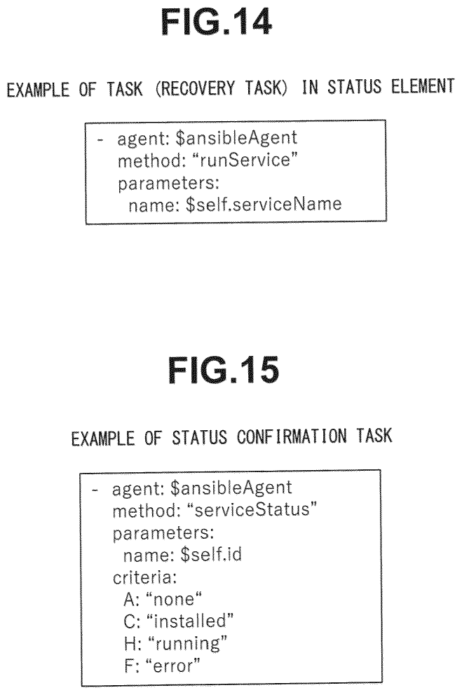

In the status element (see FIG. 11), one task (recovery task) is described for one transition. In other words, one task (recovery task) is associated with one transition. An example of a task (recovery task) omitted in FIG. 11 is shown in FIG. 14.

The fault-tolerant configuration design unit 130 replaces the transition with a task (such as the one shown in FIG. 14) according to the order indicated by the information in the status transition procedure. At this time, the task includes a reference format. When replacing the transition with a task, the fault-tolerant configuration design unit 130 writes a specific description at the reference format location within the task. The fault-tolerant configuration design unit 130 may materializes the task by referring to the expected configuration of the component type model that corresponds to the type of status element that includes the task, identifying the part of the configuration information that corresponds to that expected configuration, and inserting the specific information described in that part into the reference format in the task.

In addition, the fault-tolerant configuration design unit 130 adds depends indicating the id of the previous task to each task after the second one. This results in a recovery procedure of the form shown in FIG. 4.

Then, the fault-tolerant configuration design unit 130 rejects the proposed configuration information that includes components for which no recovery procedure can be obtained, and selects the proposed configuration information for which recovery procedures can be obtained for all components. Then, the fault-tolerant configuration design unit 130 materializes the selected proposed configuration information again in one step and performs the same process. By repeating this operation, the configuration information satisfying the condition that the recovery procedure can be generated for each component is generated in step S12.

In the above explanation, step S25 was also mentioned, but in step S25, the fault-tolerant configuration design unit 130 may terminate the process when the fault-tolerant configuration design unit 130t has generated a recovery procedure for the component in which a failure occurs.

The above describes the recovery procedure and the generation of configuration information in step S12.

Next, the generation of the specific confirmation task in step S13 will be explained.

The specific confirmation task generation unit 140 generates specific confirmation tasks for each component included in the configuration information. The specific confirmation task is materialized versions of the status confirmation task (see FIG. 11) described in the status elements of each type. An example of a status confirmation task omitted in FIG. 11 is shown in FIG. 15. The status confirmation task is described in the status element generated in advance for each component, and is associated with the component.

The specific confirmation task generation unit 140 extracts a corresponding status confirmation task for each component included in the configuration information, and generates a specific confirmation task by replacing the reference format in the status confirmation task with specific information. The specific confirmation task generation unit 140 may materialize the status confirmation task by referring to the expected configuration of the component type model corresponding to the type of the status element that includes the status confirmation task, identifying the part corresponding to that expected configuration from the configuration information, and inserting the specific information described in that part into the reference format in the status confirmation task. As a result, a specific confirmation task is obtained.

The status confirmation task differs from the task (recovery task) shown in FIG. 14 in that it includes criteria information. Other than this, the description format is the same for the status confirmation task and the task shown in FIG. 14.

Next, the generation of the status monitoring procedure in step S14 will be explained. The status monitoring procedure generation unit 150 generates a status monitoring procedure based on the information in the form of a graph in which the reference relationship of the expected configuration is formed. First, the graph format information formed by the reference relationships of the expected configuration will be explained.

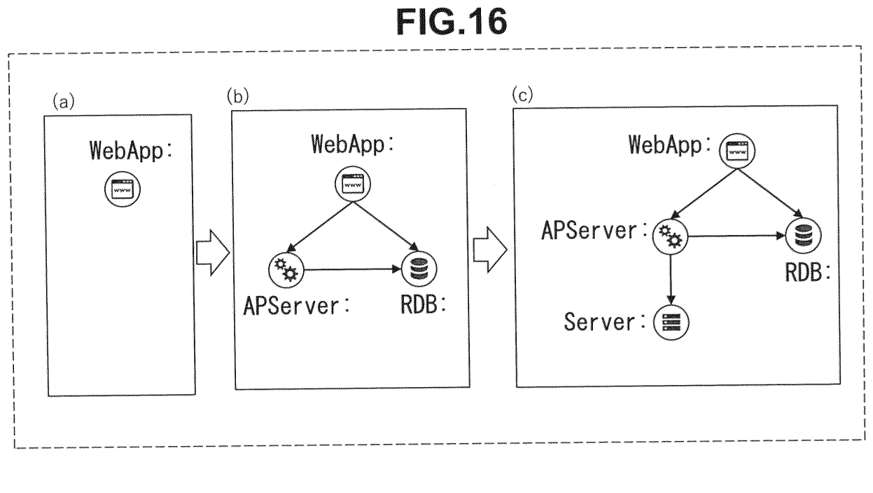

FIG. 16 is a schematic graph showing an example of a materialization of the proposed configuration information. In FIG. 16, the proposed configuration information is represented schematically as a graph. Here, a case will be considered where the system requirements shown in (a) are input. At this time, (a) includes only one WebApp type component. Therefore, by applying the expected configuration defined in a component type model of the WebApp type to that component, the proposed configuration information shown in (b) is generated. In reality, multiple proposed configuration information may be generated and one proposed configuration information is selected from among them, but here it is assumed that only (b) is generated and (b) is selected. Then, multiple proposed configuration information are generated by applying applicable materialization for each of the components that can be materialized among components included in the configuration proposal in (b). One reasonable configuration information proposal is selected from among the multiple configuration information proposals. Here, it is assumed that the proposed configuration information shown in (c) is selected.

Here, the proposed configuration information shown in (b) is obtained by applying an expected configuration including the APServer type component, the RDB type component, and the relationship connecting the two, etc., to the Web App type component in the proposed configuration information shown in (a). The proposed configuration information shown in (c) is obtained by applying an expected configuration including the Server type component and the relationship connecting the APServer type component and the Server type component to the APServer type component in the proposed configuration information shown in (b).

By the way, there is a dependency relationship between a component and another component included in the expected configuration of that component, where the former component depends on the latter component. Component A depends on component B means that component B is necessary for component A to exist.

In the example shown in FIG. 16, there are dependency relationships where the WebApp type component depends on the APServer component and RDB type component, and the APServer type component depend on the Server type component.

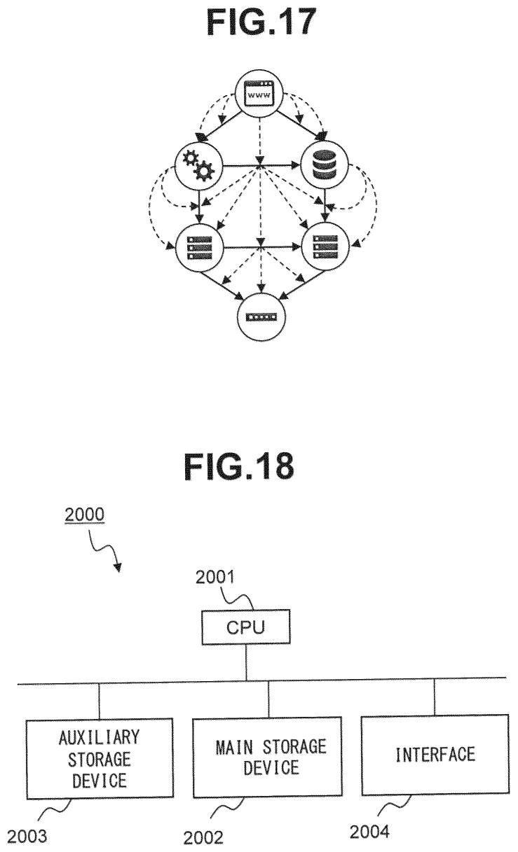

FIG. 17 is a graph showing the dependency relationships among the components included in the configuration information, represented by dotted arrows. Information that connects components with dependencies is represented by information in graph form.

The status monitoring procedure generation unit 150 generates a status monitoring procedure by converting the above graph format information (for example, FIG. 17), in which components are connected by dependency relationships, as follows. That is, the status monitoring procedure generation unit 150 replaces the components in the graph with specific confirmation tasks, and replaces the dependency relationship among the components with order relationships of execution among specific confirmation tasks. Specifically, when the component A depends on the component B, the status monitoring procedure generation unit 150 describes the id of the specific confirmation task of the component A in the depends of the specific confirmation task of the component B. As a result, in the generated status monitoring procedure, the specific confirmation task of the component B is executed after the status confirmation task of the component A is executed.

In addition, the status monitoring procedure generation unit 150 does not describe depends on the specific confirmation task that is replaced by the component that is not dependent on other components.

Among the specific confirmation tasks included in the status monitoring procedure, the specific confirmation task for which no depends are described is the first specific confirmation task, and the specific confirmation task in which the depends are described is the second specific confirmation task.

The above describes the generation of the status monitoring procedure in step S14.

In step S22 of FIG. 9, the troubleshooting unit 160 confirms the status of the regularly monitored target according to the first specific confirmation task among specific confirmation tasks included in the status monitoring procedure.

When the status of a component is determined to be abnormal status in step S23 of FIG. 9, the troubleshooting unit 160 executes one or more specific confirmation tasks that depend on the specific confirmation task of the component that is determined to be in an abnormal status. In other words, the troubleshooting unit 160 executes one or more specific confirmation tasks that have the id of the specific confirmation task of the component determined to be in an abnormal status described in depends. If any of those components are determined to be in an abnormal status, the troubleshooting unit 160 executes one or more specific confirmation tasks that depend on the specific confirmation task of the component determined to be in an abnormal status in the same manner. This operation is repeated, and the troubleshooting unit 160 identifies the component in which a failure occurs (step S24).

For example, suppose that an abnormal status is obtained as a result of execution of the specific confirmation task for WebApp. In this case, the troubleshooting unit 160 executes the specific confirmation task for the APServer and the RDB. For example, when the execution result of the specific confirmation task for the APServer indicates an abnormal status, the troubleshooting unit 160 executes a specific confirmation task for the Server that hosts the APServer. When the status of the Server is normal, the troubleshooting unit 160 determines that a failure has occurred in the APServer. In this way, the component in which the fault occurs is identified.

After step S24, the fault-tolerant configuration design unit 130 generates a recovery procedure for the component in which a failure occurs (step S25).

Then, the recovery procedure execution unit 170 restores the system by restoring the component in which a failure occurs according to the recovery procedure (step S26).

According to the present disclosure, by simply inputting a system requirement, the configuration information of the system can be generated so that it meets the requirement that recovery procedures can be generated for each component in the system. Thus, it is possible to generate system configuration information so that a system can be monitored and necessary recovery procedures can be generated according to the monitoring result.

In addition, the troubleshooting unit 160 confirms the status of the regularly monitored target according to the first specific confirmation task included in the state monitoring procedure, and when the status of the regularly monitored target becomes abnormal, the troubleshooting unit 160 identifies the component where the failure is occurring according to the second specific confirmation task. Thus, the load of the monitoring process can be reduced.

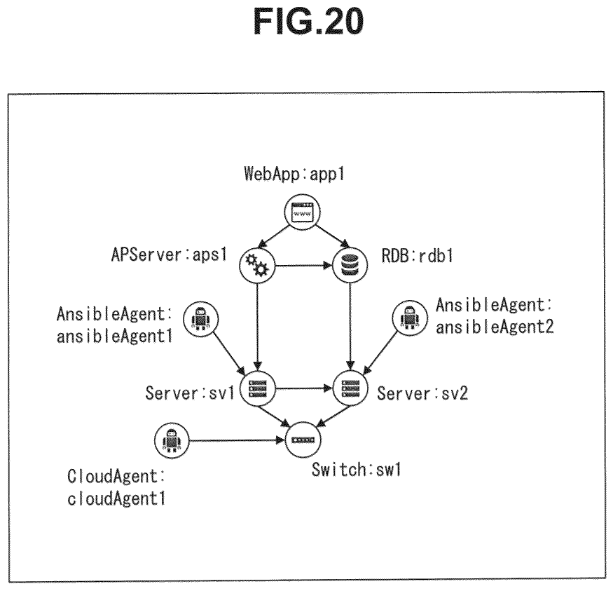

In the above example embodiment, an agent is shown as the entity that executes tasks in the recovery procedure and the status monitoring procedure. For example, in the recovery procedure shown in FIG. 4 and the status monitoring procedure shown in FIG. 7, two instances of agent, “ansibleAgent1” and “cloudAgent1”, appear. These instances of agent may appear as configuration parts in the proposed configuration information. In the above example, the configuration part whose id is “ansibleAgent1” and the configuration part whose id is “cloudAgent1” appear in the proposed configuration information. The process in which an agent appears in proposed configuration information is the same as the process in which other configuration parts appear in proposed configuration information. That is, an agent is added to the proposed configuration information by being included in the expected configuration of other components. FIG. 20 shows a graph showing an example of a system configuration in which an agent has been added.

FIG. 18 is a schematic block diagram showing an example of a computer configuration for the system operation mechanism automatic construction device. The computer 2000, for example, comprises a CPU 2001, a main storage device 2002, an auxiliary storage device 2003, and an interface 2004.

The system operation mechanism automatic construction device of the present disclosure is realized by a computer 2000, for example. The operation of the system operation mechanism automatic construction device is stored in the auxiliary storage device 2003 in the form of a program (system operation mechanism automatic construction program). The CPU 2001 reads the program from the auxiliary storage device 2003, deploys the program in the main storage device 2002, and executes the processes described in the above example embodiment according to the program.

The auxiliary storage device 2003 is an example of a non-temporary tangible medium. Other examples of non-transitory tangible media include magnetic disks, optical disks, CD-ROM (Compact Disk Read Only Memory), DVD-ROM (Digital Versatile Disk Read Only Memory), semiconductor memory, etc., connected through interface 2004.

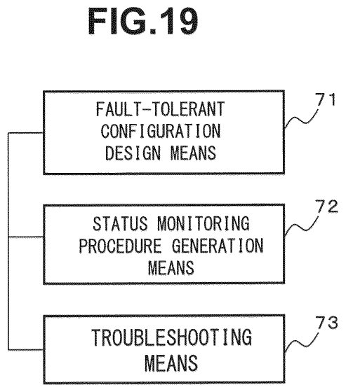

Next, an overview of the system operation mechanism automatic construction device for this disclosure will be described. FIG. 19 is a block diagram showing an overview of the system operation mechanism automatic construction device of the present disclosure. The system operation mechanism automatic construction device comprises fault-tolerant configuration design means 71, status monitoring procedure generation means 72, and troubleshooting means 73.

The fault-tolerant configuration design means 71 (for example, the fault-tolerant configuration design unit 130) generates configuration information of a system that satisfies a given system requirement so as to satisfy a condition that a recovery procedure for each component included in the system can be generated, and generating a recovery procedure for the component in which a failure occurs when a failure occurs in any of the components.

The status monitoring procedure generation means 72 (for example, the status monitoring procedure generation unit 150) generates a status monitoring procedure which is a set of specific confirmation tasks for confirming a status of each component included in the system.

The troubleshooting means 73 (for example, the troubleshooting unit 160) monitors the system using the status monitoring procedure.

With such a configuration, it is possible to generate system configuration information so that a system can be monitored and necessary recovery procedures can be generated according to the monitoring result.

A part of or all of the above example embodiments may also be described as, but not limited to, the following supplementary notes.

### Supplementary Note 1

An operation mechanism automatic construction device comprising:
fault-tolerant configuration design means for generating configuration information of a system that satisfies a given system requirement so as to satisfy a condition that a recovery procedure for each component included in the system can be generated, and generating a recovery procedure for the component in which a failure occurs when a failure occurs in any of the components,
status monitoring procedure generation means for generating a status monitoring procedure which is a set of specific confirmation tasks for confirming a status of each component included in the system, and
troubleshooting means for monitoring the system using the status monitoring procedure.

### Supplementary Note 2

The system operation mechanism automatic construction device according to Supplementary note 1, comprising:
recovery procedure execution means for restoring the system by restoring the component in which a failure occurs using the generated recovery procedure.

### Supplementary Note 3

The system operation mechanism automatic construction device according to Supplementary note 1, wherein
the status monitoring procedure generation means generates the status monitoring procedure that includes a first specific confirmation task for confirming a status of a regular monitoring target, which is a component that should be regularly monitored, and a second specific confirmation task for identifying the component in which a failure occurs when the regular monitoring target is in an abnormal status,
the troubleshooting means identifies the component in which a failure occurs according to the second specific confirmation task when the regular monitoring target becomes abnormal status.

### Supplementary Note 4

The system operation mechanism automatic construction device according to any one of Supplementary notes 1 to 3, wherein
the fault-tolerant configuration design means generates configuration information by taking the configuration information representing the system requirements as an initial status of the configuration information, and repeatedly executing of materializing the configuration information one step, and of selecting, among proposed configuration information obtained by materialization, proposed configuration information that can generate the recovery procedure for each component included in the proposed configuration information.

### Supplementary Note 5

A system operation mechanism automatic construction method, wherein:
a computer generates configuration information of a system that satisfies a given system requirement so as to satisfy a condition that a recovery procedure for each component included in the system can be generated,
the computer generates a status monitoring procedure which is a set of specific confirmation tasks for confirming a status of each component included in the system,
the computer monitors the system using the status monitoring procedure, and
the computer generates the recovery procedure for the component in which a failure occurs when a failure occurs in any of the components.

### Supplementary Note 6

A system operation mechanism automatic construction program for causing a computer to execute:
a fault-tolerant configuration design process of generating configuration information of a system that satisfies a given system requirement so as to satisfy a condition that a recovery procedure for each component included in the system can be generated,
a status monitoring procedure generation process of generating a status monitoring procedure which is a set of specific confirmation tasks for confirming a status of each component included in the system,
a troubleshooting process of monitoring the system using the status monitoring procedure, and
a recovery procedure generation process of the recovery procedure for the component in which a failure occurs when a failure occurs in any of the components.

Some or all of the configurations described in Supplementary notes 2 to 4, which are dependent on Supplementary note 1 described above, can be dependent on Supplementary notes 5 and 6 by the same dependency relationship as Supplementary notes 2 to 4. Furthermore, not limited to Supplementary note 1, Supplementary note 5, and Supplementary note 6, some or all of the configurations described as Supplementary notes can be similarly subordinated to various hardware, software, various recording means for recording software, or systems, to the extent not deviating from the example embodiments described above.

Although the present disclosure has been described above with reference to example embodiments, the present disclosure is not limited to the above example embodiments. Various changes can be made to the configuration and details of the present disclosure that can be understood by those skilled in the art within the scope of the present disclosure.

### INDUSTRIAL APPLICABILITY

The present disclosure is suitably applied to a system operation mechanism automatic construction device that generates system configuration information and also monitors the system.

What is claimed is:

1. An operation mechanism automatic construction device comprising:
a memory storing software instructions, and
one or more processors configured to execute the software instructions to
generate configuration information of a system that satisfies a given system requirement so as to satisfy a condition that a recovery procedure for each component included in the system can be generated, and generates a recovery procedure for the component in which a failure occurs when a failure occurs in any of the components,
generate a status monitoring procedure which is a set of specific confirmation tasks for confirming a status of each component included in the system, and
monitor the system using the status monitoring procedure.

2. The system operation mechanism automatic construction device according to claim 1,
wherein the one or more processors are configured to further execute the software instructions to
restore the system by restoring the component in which a failure occurs using the generated recovery procedure.

3. The system operation mechanism automatic construction device according to claim 1, wherein
the one or more processors are configured to execute the software instructions to
generate the status monitoring procedure that includes a first specific confirmation task for confirming a status of a regular monitoring target, which is a component that should be regularly monitored, and a second specific confirmation task for identifying the component in which a failure occurs when the regular monitoring target is in an abnormal status, and
identify the component in which a failure occurs according to the second specific confirmation task when the regular monitoring target becomes abnormal status.

4. The system operation mechanism automatic construction device according to claim 1, wherein
the one or more processors are configured to execute the software instructions to generate configuration information by taking the configuration information representing the system requirements as an initial status of the configuration information, and repeatedly executing of materializing the configuration information one step, and of selecting, among proposed configuration information obtained by materialization, proposed configuration information that can generate the recovery procedure for each component included in the proposed configuration information.

5. The system operation mechanism automatic construction device according to claim 2, wherein
the one or more processors are configured to execute the software instructions to generate configuration information by taking the configuration information representing the system requirements as an initial status of the configuration information, and repeatedly executing of materializing the configuration information one step, and of selecting, among proposed configuration information obtained by materialization, proposed configuration information that can generate the recovery procedure for each component included in the proposed configuration information.

6. The system operation mechanism automatic construction device according to claim 3, wherein
the one or more processors are configured to execute the software instructions to generate configuration information by taking the configuration information representing the system requirements as an initial status of the configuration information, and repeatedly executing of materializing the configuration information one step, and of selecting, among proposed configuration information obtained by materialization, proposed configuration information that can generate the recovery procedure for each component included in the proposed configuration information.

7. A system operation mechanism automatic construction method, implemented by a processor, comprising:
generating configuration information of a system that satisfies a given system requirement so as to satisfy a condition that a recovery procedure for each component included in the system can be generated,
generating a status monitoring procedure which is a set of specific confirmation tasks for confirming a status of each component included in the system,
monitoring the system using the status monitoring procedure, and
generating the recovery procedure for the component in which a failure occurs when a failure occurs in any of the components.

8. The system operation mechanism automatic construction method according to claim 7, further comprising
restoring the system by restoring the component in which a failure occurs using the generated recovery procedure.

9. The system operation mechanism automatic construction method according to claim 7, further comprising
generating the status monitoring procedure that includes a first specific confirmation task for confirming a status of a regular monitoring target, which is a component that should be regularly monitored, and a second specific confirmation task for identifying the component in which a failure occurs when the regular monitoring target is in an abnormal status, and
identifying the component in which a failure occurs according to the second specific confirmation task when the regular monitoring target becomes abnormal status.

10. The system operation mechanism automatic construction method according to claim 7, further comprising
generating configuration information by taking the configuration information representing the system requirements as an initial status of the configuration information, and repeatedly executing of materializing the configuration information one step, and of selecting, among proposed configuration information obtained by materialization, proposed configuration information that can generate the recovery procedure for each component included in the proposed configuration information.

11. A non-transitory computer readable storage medium for storing a system operation mechanism automatic construction program for causing a computer to execute:
generating configuration information of a system that satisfies a given system requirement so as to satisfy a condition that a recovery procedure for each component included in the system can be generated,
generating a status monitoring procedure which is a set of specific confirmation tasks for confirming a status of each component included in the system,
monitoring the system using the status monitoring procedure, and
generating the recovery procedure for the component in which a failure occurs when a failure occurs in any of the components.

12. The non-transitory computer readable storage medium according to claim 11, wherein
the system operation mechanism automatic construction program causes the computer to execute restoring the system by restoring the component in which a failure occurs using the generated recovery procedure.

13. The non-transitory computer readable storage medium according to claim 11, wherein
the system operation mechanism automatic construction program causes the computer to execute
generating the status monitoring procedure that includes a first specific confirmation task for confirming a status of a regular monitoring target, which is a component that should be regularly monitored, and a second specific confirmation task for identifying the component in which a failure occurs when the regular monitoring target is in an abnormal status, and
identifying the component in which a failure occurs according to the second specific confirmation task when the regular monitoring target becomes abnormal status.

14. The non-transitory computer readable storage medium according to claim 11, wherein
the system operation mechanism automatic construction program causes the computer to execute generating configuration information by taking the configuration information representing the system requirements as an initial status of the configuration information, and repeatedly executing of materializing the configuration information one step, and of selecting, among proposed configuration information obtained by materialization, proposed configuration information that can generate the recovery procedure for each component included in the proposed configuration information.
